(19) United States
(12) Patent Application Publication
(10) Pub. No.: US 2011/0157224 A1
(43) Pub. Date: Jun. 30, 2011

(54) PRESENTATION DEVICE

(76) Inventor: Hiromasa Kaneko, Nagoya (JP)

(21) Appl. No.: 12/902,717

(22) Filed: Oct. 12, 2010

(30) Foreign Application Priority Data
Dec. 25, 2009 (JP) 2009-294875

(51) Int. Cl. G09G 5/00

(52) U.S. Cl. 345/634

(57) ABSTRACT

The presentation device 100 is adapted to acquire image data representing a first image, and to additionally acquire overlay information that records in advance at least a placement location for a second image to be overlaid onto the first image for the purpose of masking or highlighted display of at least a portion of the first image. Once overlay information associated with image data is acquired, on the basis of the acquired overlay information, a second image is overlaid on the first image represented by this image data, and the resultant image is output. If a control input to delete the second image is received, the presentation device 100 outputs the first image after deleting the second image.

### CROSS-REFERENCE TO RELATED APPLICATION

The present application claims the priority based on Japanese Patent Application No. 2009-294875 filed on Dec. 25, 2009, the disclosure of which is hereby incorporated by reference in its entirety.

### BACKGROUND

1. Technical Field

The present invention relates to a presentation device adapted display images on an external display device.

2. Related Art

Certain conventional presentation devices, such as that disclosed in JP-A-2008-193391 for example, are furnished with a function for masking (hiding) portions of an output image, and a function for highlighting (emphasizing) portions of an output image. Using such functions, during a presentation being made in a classroom for example, it would be possible to hide the correct answer portion of an examination paper, or to highlight a certain section to which attention should be directed.

However, in such conventional presentation devices, each time that the masking function or highlighting function is used it is necessary to use specify a location to be masked or highlighted using a remote control or a control panel located on the console, so the risk of the presentation proceeding slowly was a problem.

### SUMMARY

An object of the invention is to provide a technique for enhancing the convenience of the masking function and the highlighting function in a presentation device.

According to an aspect of the invention there is provided a presentation device. The device includes an image data acquisition portion that acquires image data which represents a first image; an overlay information acquisition portion that acquires overlay information which has recorded therein in advance at least a placement location for a second image to be overlaid onto the first image for the purpose of masking or highlighted display of at least a portion of the first image; an image processing portion that upon acquisition of overlay information associated with the acquired image data, overlays the second image on the first image represented by the acquired image data based on the acquired overlay information, and outputs the overlaid image; and a control input receiving portion adapted to receive a control input to delete the second image; wherein in the event that the control input is received by the control input receiving portion, the image processing portion outputs the first image after deleting the second image from the overlaid image.

According to this feature, if the overlay information associated with image data is acquired, on the basis of placement location information recorded beforehand in the overlay information, the second image for the purpose of masked or highlighted display may be superimposed on the first image represented by this image data. Accordingly, there is no need to specify a location for masking or highlighting each time that the masking function or highlighting function is used, thus enhancing the convenience of the masking function and the highlighting function in a presentation device.

Preferably if two or more placement locations of the second image are recorded in the acquired overlay information, the image processing portion overlays the second image on the respective locations; and the image processing portion deletes the second images according to a prescribed sequence, each time that the control input is received by the control input receiving portion.

According to this feature, the second images may be positioned at multiple locations on the first image, and additionally, these second images may be deleted according to a prescribed sequence.

Preferably the overlay information contains sequence information relating to a sequence for carrying out the deletion; and the image processing portion carries out deletion of the second images according to the sequence information.

According to this feature, it is possible to delete the second images according to a pre-established sequence.

Preferably if the control input is received by the control input receiving portion subsequent to deletion of all of the second images, the image processing portion again overlays all of the second images on the first image.

According to this feature, it is possible to repeatedly delete and redisplay second images through a single operation.

Preferably the overlay information records class information representing classes of the second image; and the image processing portion overlays a second image having a format in accordance with the class information.

According to this feature, it is possible for example to toggle between a second image format for use during masking and a second image format for use during highlighting, according to class information contained in the overlay information.

Preferably the overlay information is recorded in the image file that contains the image data.

According to this feature, because the image data and the overlay information are recorded in the same image file, it is a simple matter to associate the image data and the overlay information.

Preferably the presentation device further comprises an overlay information storage portion that stores the overlay information in a form associated with the image data; wherein the overlay information acquisition portion acquires the overlay information from the overlay information storage portion.

According to this feature, even if the image data and the overlay information are managed individually, it is a simple matter to acquire the overlay information associated with the image data.

Preferably the control input receiving portion is additionally adapted to receive a command to zoom or scroll the first image; and the image processing portion zooms or scrolls the first image by a magnification factor or by a distance in accordance with the zoom or scroll command, and likewise zooms or scrolls the second image by the magnification factor or by the distance.

According to this feature, zooming and scrolling of the first image is carried out in comparable fashion on the second image as well, thus preventing the masked area from becoming exposed, and preventing the highlighted display area from shifting out of place.

In addition to the presentation device aspects described above, other aspects of the present invention may include an image output control method by a presentation device; a computer program; or a recording medium having a computer program recorded thereon.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an illustration depicting the use of a presentation device according to an embodiment of the invention;

FIG. 2 is an illustration showing an example of an image file containing recorded overlay information;

FIG. 3 is a block diagram showing the internal configuration of a presentation device;

FIG. 4 is a flowchart of an image playback process;

FIG. 5 is a detailed flowchart of a masking process;

FIG. 6 is a conceptual depiction of a zooming/scrolling process; and

FIG. 7 is a detailed flowchart of a highlighting process.

### DESCRIPTION OF THE PREFERRED EMBODIMENTS

### A. Features of Presentation Device

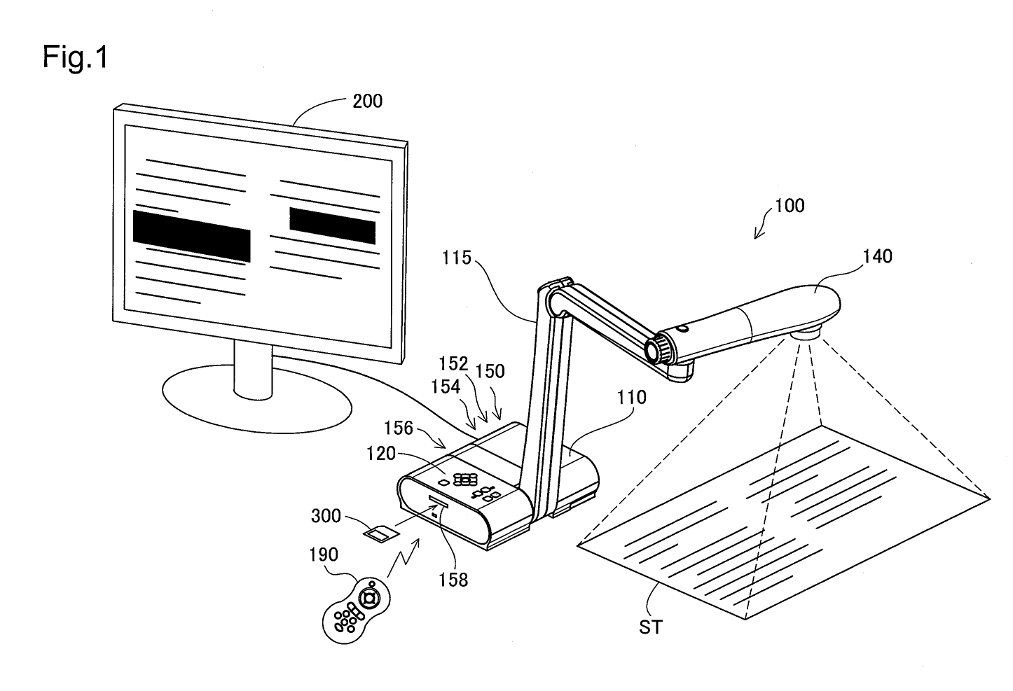

FIG. 1 is an illustration depicting the use of a presentation device according to an embodiment of the invention. The presentation device 100 includes a base 110 adapted to be positioned on a surface such as a desktop; a control panel 120 provided to the base 110, for receiving control inputs from a user; a support post 115 extending upward from the base 110, and a camera head 140 mounted on the distal end of the support post 115. Control inputs by the user may be received by a remote control 190 as well, in addition to the control panel 120.

The camera head 140 houses a CCD image sensor, and is adapted to capture a document ST that has been positioned on the desktop for example. On the rear panel of the base 110 there are provided as a video input terminal an analog RGB input terminal 150, and as video output terminals an analog RGB output terminal 152 and a composite output terminal 154. Also provided on the rear panel of the base 110 is a USB terminal 156 used as a connection interface with a computer (not shown). An external display device such as a liquid crystal display 200, a projector, or a television is connected to the analog RGB output terminal 152 or composite output terminal 154.

A memory card slot 158 is provided on a side panel of the base 110. A memory card 300 that records image files of EXIF format for example is inserted into the memory card slot 158. EXIF is an image file format standardized by JEITA (Japan Electronics and Information Technology Industries Association). In addition to image data, the image file contains information such as the image shooting date, the model of the shooting device, the resolution, the shutter speed, and so on, recorded as EXIF information in accordance with this EXIF standard. The EXIF information also has a tag called the MakerNote tag; individual manufacturers can record proprietary information in this MakerNote tag.

The presentation device 100 loads an image file recorded on the memory card 300, and on the liquid crystal display 200 produces a display of an image represented by this image file (herein termed the “input image”). At this time, if information relating to masking or highlighting is recorded in the image file (more specifically, in the MakerNote tag in the EXIF information contained in the image file), the presentation device 100 masks (hides) or highlights (emphasizes) part of the input image. Herein, information relating to masking recorded in an image file is termed “mask information” and information relating to highlighting is termed “highlight information”. Mask information and highlight information are referred to collectively as “overlay information”.

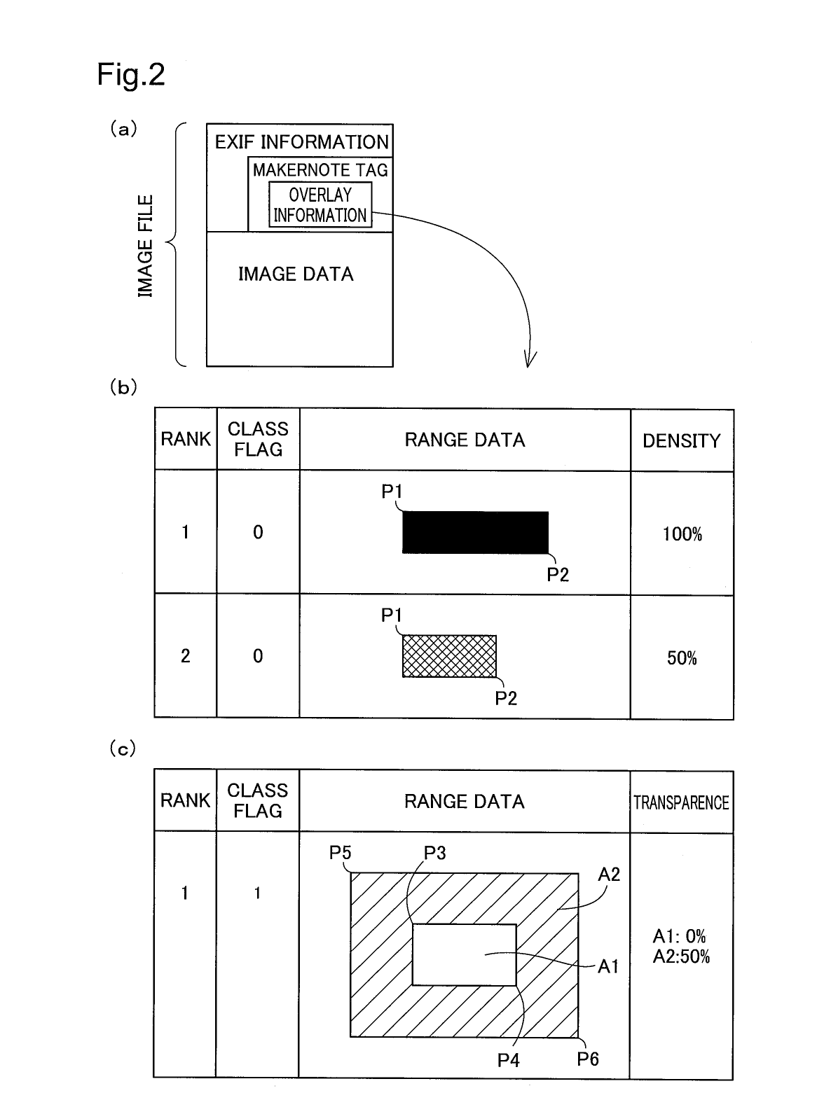

FIG. 2 is an illustration showing an example of an image file containing recorded overlay information. As shown in FIG. 2 (a), the image file has a field containing recorded EXIF information and a field containing recorded image data. The image data consists of data in JPEG format for example. In the present embodiment, overlay information is recorded in the MakerNote tag in the EXIF information.

FIG. 2 (b) shows an example of mask information recorded as overlay information. Multiple items of mask information may be recorded in the overlay information, with each item of mask information including “Rank”, “Class Flag”, “Range Data”, and “Density” parameters. “Rank” indicates the order in which to delete the mask. “Class Flag” indicates whether the overlay information is mask information or highlight information. In the present embodiment, if the overlay information indicates mask information, the Class Flag is set to “0”, whereas for highlight information the Class Flag is set to “1”. “Range Data” indicates a range and a placement location for masking, and records an upper left coordinate P1 and a lower right coordinate P2 for carrying out masking. “Density” indicates the depth of color (in the present embodiment, black) of the mask. Herein, the rectangular image represented by this mask information is termed a “mask image”. In addition to the above information, the mask information may also record information representing the mask shape, color, or pattern, or its transparence.

FIG. 2 (c) shows an example of highlight information recorded as overlay information. Highlight information includes “Rank”, “Class Flag”, “Range Data”, and “Transparence” parameters. “Range Data” indicates a location and a range for highlighting, and records an upper left coordinate P3 and a lower right coordinate P4 of section for carrying out highlighting (hereinafter termed a “highlight area”), as well as an upper left coordinate P5 and a lower right coordinate P6 of an area for carrying out masking of the perimeter of the section (hereinafter termed a “masking area”). Transparence A1 of the highlighted area and transparence A2 of the masking area are recorded as the “Transparence” parameters. Herein, the frame-shaped image represented by this highlight information is termed the “highlight image”. In addition to the above information, the highlight information may also record information representing the shape, color, or pattern of the highlight area or masking area. In the present embodiment, only one item of highlight information is recorded in overlay information. Accordingly, recording of “Rank” may be omitted. In the present embodiment, the masking area is included in the highlight information, but the masking area may be omitted. In this case, areas apart from the highlight area would all be treated as masking areas.

The image file depicted in FIG. 2 may be generated by a special-purpose application installed on a computer for example. For example, using this application the user may bring up on the screen an image targeted for setting a mask or highlight, and then use a mouse, tablet, or the like to define a range, density, etc. for the mask or highlight on the image. Once the settings are completed, the application then generates an image file in which these settings are written to the MakerNote tag of the EXIF information and records the file to the memory card 300. The image file depicted in FIG. 2 may be generated in this manner. It is also possible to generate image files like that depicted in FIG. 2 by incorporating into in the presentation device 100 functionality comparable to that of the application described above. In the present embodiment, the mask information shown in FIG. 2 (b) and the highlight information shown in FIG. 2 (c) are not combined in a single image file; rather, only one or the other is recorded in the file.

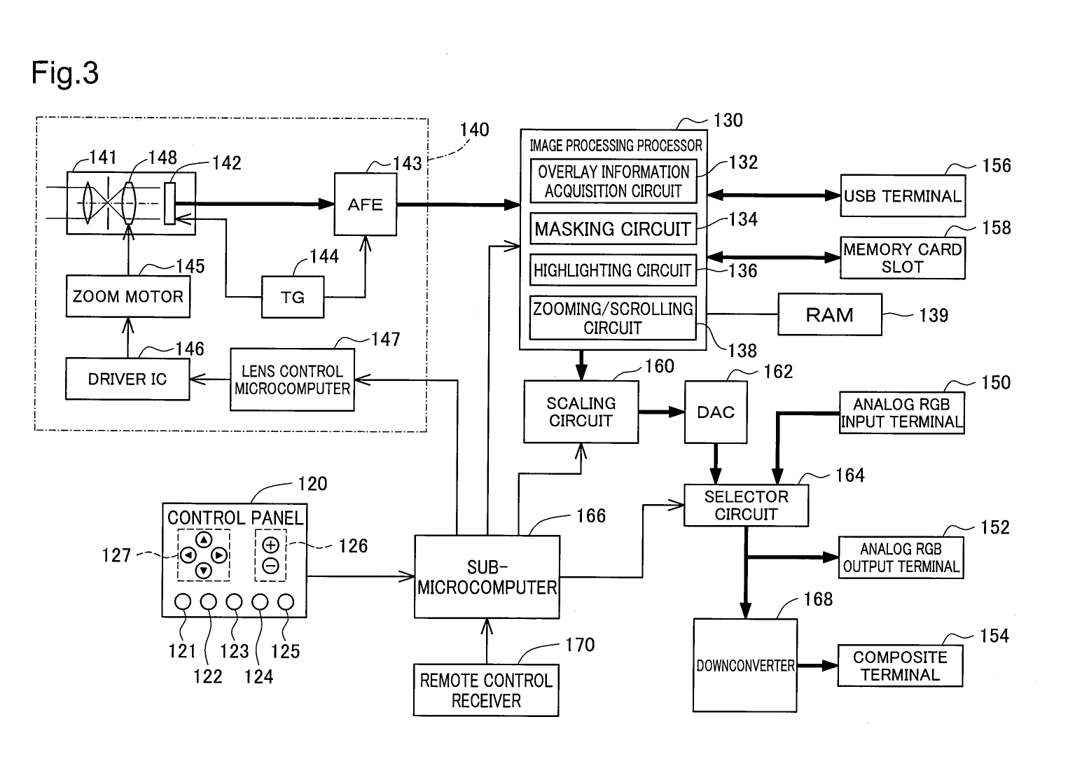

FIG. 3 is a block diagram showing the internal configuration of the presentation device 100. In the drawing, the section shown inside broken lines indicates the arrangement inside the camera head 140, while other sections primarily represent arrangements inside the base 110.

The camera head 140 includes a lens unit 141 for capturing the document ST; a CCD image sensor 142 for converting light collected by the lens unit 141 to an electrical signal; an analog front end 143 for converting the analog signal output from the CCD image sensor 142 to a digital signal; and a timing generator 144 for outputting a reference pulse for operation of the CCD image sensor 142 and the analog front end 143. It would be possible to use a CMOS image sensor in place of the CCD image sensor 142.

The lens unit 141 is composed of multiple lenses, and includes a zoom lens 148. Inside the camera head 140 there are provided a zoom motor 145 for moving this zoom lens 148 towards the telephoto end or towards the wide-angle end to carry out optical zoom; and a driver IC 146 for driving the zoom motor 145. The driver IC 146 is connected to a lens control microcomputer 147, and in response to an instruction from the lens control microcomputer 147 controls the zoom direction and zoom speed by regulating the frequency or voltage of a signal that is output to the zoom motor 145.

The picture signal output from the analog front end 143 is input to an image processing processor 130. The USB terminal 156 and the memory card slot 158 are connected to the image processing processor 130. The image processing processor 130 is able to input images from the analog front end 143, and is also able to input images from a memory card 300 installed in the memory card slot 158, or from a computer connected to the USB terminal 156.

The image processing processor 130 acquires an image from the analog front end 143, from the memory card 300 installed in the memory card slot 158, or from the computer connected to the USB terminal 156, and saves it temporarily to the RAM 139. Then, using the RAM 139 as the work area, it carries out image processing of various kinds on the acquired image. Examples of image processing carried out by the image processing processor 130 include adjustment of white balance, gamma correction, an edge sharpening process, and so on.

The image processing processor 130 includes as internal circuits an overlay information acquisition circuit 132 for acquiring overlay information from an image file recorded on the memory card 300, a masking circuit 134 for carrying out masking, a highlighting circuit 136 for carrying out highlighting, and a zooming/scrolling circuit 138 for carrying out zooming and scrolling.

The picture signal having undergone image processing by the image processing processor 130 is then output to a scaling circuit 160. In response to an instruction from a sub-microcomputer 166, the scaling circuit 160 converts the resolution of the picture signal output by the image processing processor 130 (e.g. 1280×1024) to a resolution suitable for analog RGB output (e.g. 1024×768).

A DAC 162 is connected to the scaling circuit 320. The DAC 162 performs D/A conversion of the scaled (resolution-converted) picture signal to generate an analog RGB signal. The DAC 162 is connected to a selector circuit 164, and the analog RGB input terminal 150 is connected to this selector circuit 164. According to an instruction from the sub-microcomputer 166, the selector circuit 164 switches the input source of the picture signal to either the DAC 162 or the analog RGB input terminal 150. The picture signal output by the selector circuit 164 is output to the analog RGB output terminal 152 and to a downconverter 168. The downconverter 168 then converts the input analog RGB signal to a composite signal, and outputs this signal to the composite output terminal 154.

The base 110 also includes the control panel 120. The control panel 120 is provided for example with a Playback button 121 for playing back image files recorded on the memory card 300, a Next Page button 122 for displaying the next image, a Mask button 123 for carrying out operations relating to masking, and a Highlight button 124 for carrying out operations relating to highlighting. The control panel is additionally provided with a Select button 125 for switching the input source of the picture signal input by the selector circuit 164, a Zoom button 126 for carrying out zoom, and a Scroll button 127 for scrolling the image. When the Zoom button 126 is operated, if the image captured by the camera head 140 is currently being output, optical zoom takes place preferentially over digital zoom, whereas if an image recorded on the memory card 300 is currently being played back, only digital zoom takes place. The Scroll button 127 is functional only in digital zoom mode.

The sub-microcomputer 166 is connected to the control panel 120. The sub-microcomputer 166 receives various control signals from the control panel 120 and outputs the control signals to the image processing processor 130 and to the lens control microcomputer 147. A remote control receiver 170 is also connected to the sub-microcomputer 166, and signals comparable to control signals received from the control panel 120 are received from the remote control 190 via the remote control receiver 170.

### B. Classes of Processes

### (B-1) Image Playback Process

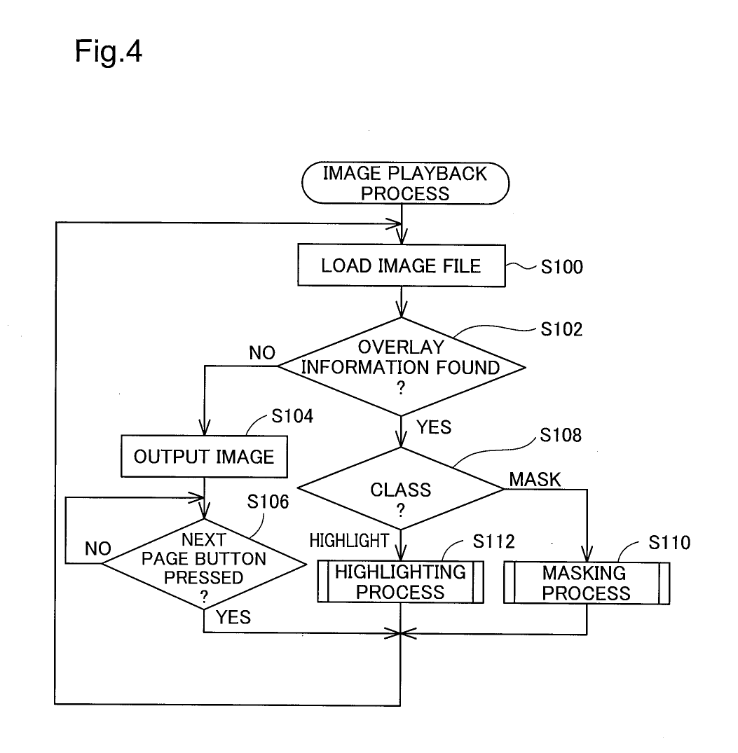

FIG. 4 is a flowchart of the image playback process executed by the image processing processor 130 of the presentation device 100. This image playback process is executed when the Playback button 121 of the control panel 120 (refers herein to the equivalent button of the remote control 190 as well) is pushed. When the Playback button 121 of the control panel 120 is pushed a second time, an interrupt is issued by the sub-microcomputer 166, whereupon the image processing processor 130 terminates the image playback process.

When this image playback process is executed, first, the image processing processor 130 reads a single image file from the memory card 300 inserted into the memory card slot 158 (Step S100). If multiple image files are recorded to the memory card 300, the image processing processor 130 loads the image files in order of file name. Loading of files may take place in some other order besides file name order, such as in order of the image file creation date or in order of recording to the memory card 300.

Once a single image file has been loaded, the image processing processor 130, through the overlay information acquisition circuit 132, decides whether overlay information (see FIG. 2) is recorded in the EXIF information of the loaded image file (Step S102). If no overlay information is recorded, the image processing processor 130 outputs an image representing the image data in the loaded image file (the input image) without further modification (Step S104). Once an input image is output from the image processing processor 130, the image is displayed on the liquid crystal display 200 through the scaling circuit 160 and the DAC 162.

When output of the input image takes place in Step S104, the image processing processor 130 stands by until the Next Page button 122 of the control panel 120 is pushed (Step S106). If during this interval the Zoom button 126 or the Scroll button 127 of the control panel 120 is pushed, the image processing processor 130 performs digital zooming or scrolling of the input image through the action of the zooming/scrolling circuit 138.

If instead it is decided in Step S102 that overlay information is recorded in the EXIF information of the image file, the image processing processor 130 then looks up the Class Flag contained in the overlay information, and decides whether the overlay information is in the class of mask information or of highlight information (Step S108). If the overlay information class is mask information, the image processing processor 130 executes a masking process, discussed later (Step S110), whereas in the case of highlight information, it executes a highlighting process, discussed later (Step S112). The image processing processor 130 repeatedly executes the image playback process described above until the Playback button is pushed a second time.

### (B-2) Masking Process

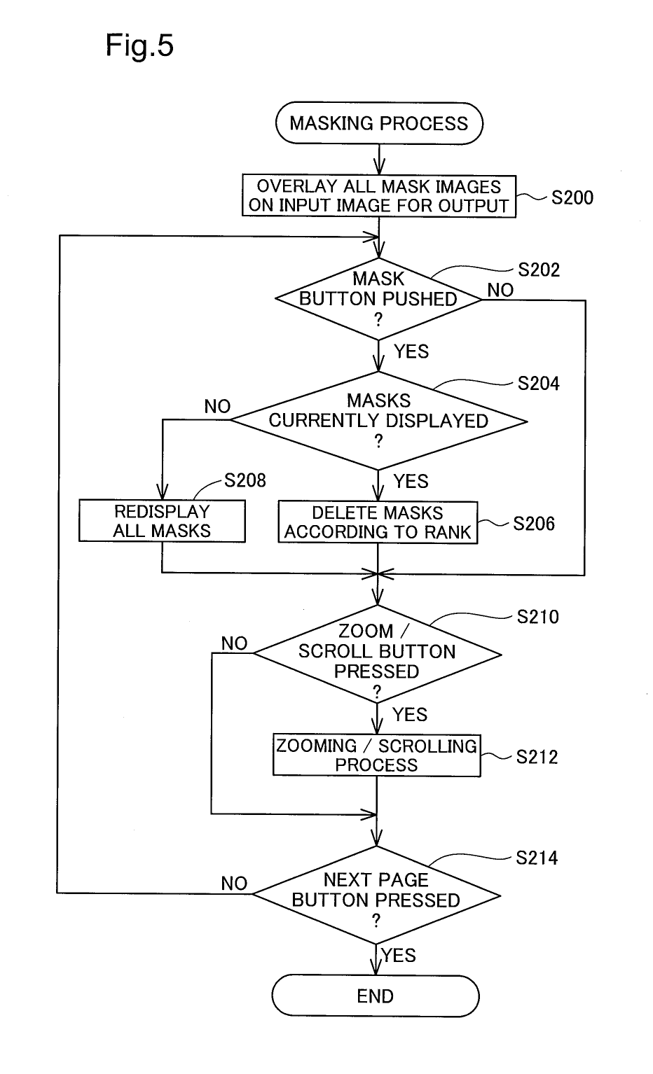

FIG. 5 is a detailed flowchart of the masking process executed in Step S110 of the image playback process described above. When this masking process is executed, first, through the masking circuit 134 the image processing processor 130 overlays onto the input image all mask images represented by the mask information contained in the image file (Step S200). That is, according to the present embodiment, if mask information is recorded in an image file, the input image is output together with an overlying mask image, without the user having to perform any particular operation.

Next, the image processing processor 130 decides whether the Mask button 123 was pushed (Step S202). If the Mask button 123 was pushed, it then decides whether one or more mask images are currently displayed (Step S204). If one or more mask images are currently displayed, through the masking circuit 134, the image processing processor 130 deletes one of the mask images currently overlying the input image (Step S206). At this time, the masking circuit 134 determines which mask image to delete according to a sequence that was recorded in the mask information. In this way, according to the present embodiment, mask images for deletion are determined according to a sequence recorded in the mask information; however, deletion may instead take place according to the order in which the mask information was recorded in the image file. In this case, there is no need to register a sequence (the rank) in the mask information beforehand.

In Step S204, if decided that no mask images are currently displayed, the image processing processor 130 prompts the masking circuit 134 to redisplay all of the mask images (Step S208). That is, according to the present embodiment, a single mask image is deleted each time that the Mask button 123 is pushed, and after all of the mask images are deleted, if the Mask button 123 is then pushed again, all of the mask images are displayed again.

If in Step S202 it is decided that the Mask button 123 was not pushed, or if deletion of a mask image (Step S206) or redisplay of all masks (Step S208) has taken place, the image processing processor 130 then decides whether there has been an operation using the Zoom button 126 or the Scroll button 127 (Step S210). If there has been an operation of Zoom button 126 or the Scroll button 127, a zooming/scrolling process is carried out by the zooming/scrolling circuit 138 (Step S212). During this zooming/scrolling process, the zooming/scrolling circuit 138 performs digital zooming or scrolling of the input image, as well as performing digital zooming or scrolling of any mask images overlaying the input image, in the same manner as the input image. In the absence of operation of the Zoom button 126 or the Scroll button 127, the image processing processor 130 skips Step S212.

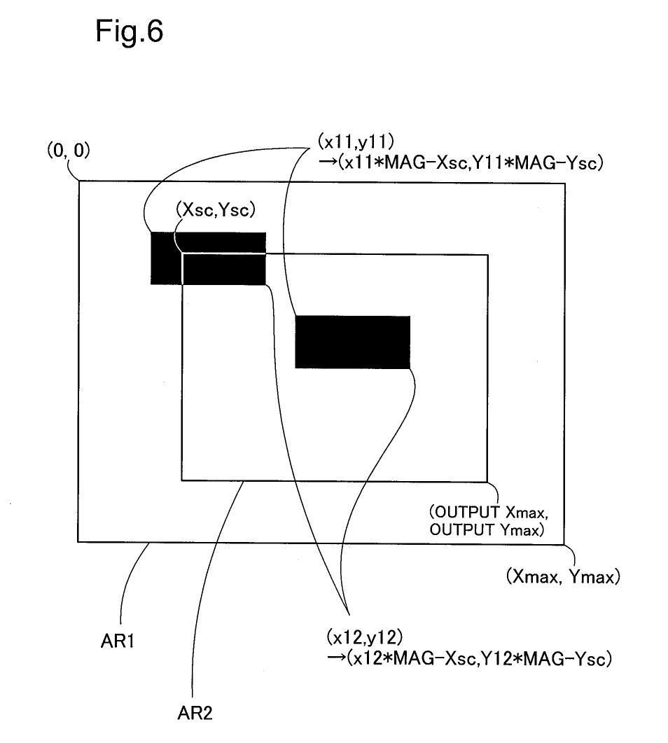

FIG. 6 is a conceptual depiction of a zooming/scrolling process. An area AR1 shown in FIG. 6 represents the area of the entire input image which is displayed full screen prior to digital zooming and scrolling; and an area AR2 represents an area in part of the input image, which is shown enlarged in full screen subsequent to digital zooming and scrolling. For example, let the magnification ratio of the area AR2 to the area AR1 be denoted as “MAG”, and let the distance which the center of the area AR2 travels from the center of the of the area AR1 when scrolled be denoted as “Xsc” in the X direction and “Ysc” in the Y direction. As shown in FIG. 6, in the zooming/scrolling process of Step S212, the upper left coordinates (X11, Y11) of the mask image are converted to (X11*MAG−Xsc, Y11*MAG−Ysc), and the lower right coordinates (X12, Y12) of the mask image are converted to (X12*MAG−Xsc, Y12*MAG−Ysc). On the basis of coordinates converted in this way, each mask image is output overlying the input image subsequent to digital zooming and scrolling (area AR2). Consequently, as shown in FIG. 6, the relative position and range of a mask image positioned on the input image is unchanged before and after digital zooming or before and after scrolling, and the mask image does not shift from the masked range prior to that time.

Once the zooming/scrolling process is completed (or if skipped), the image processing processor 130 finally decides whether the Next Page button 122 has been pushed (Step S214). If the Next Page button 122 has not been pushed, the image processing processor 130 returns the process to Step S202. On the other hand, if the Next Page button 122 has been pushed, the masking process terminates. If this masking process is terminated, the image processing processor 130 returns the process to the image playback process illustrated in FIG. 4. Accordingly, the next image file is loaded by Step S100 of the image playback process.

### (B-3) Highlighting Process

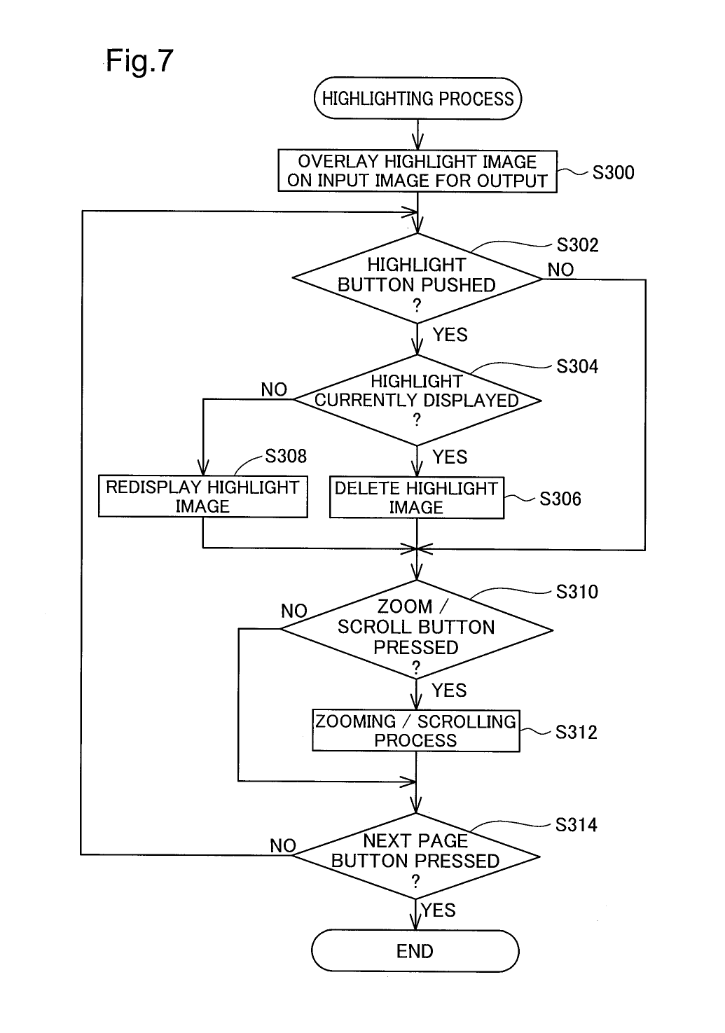

FIG. 7 is a detailed flowchart of a highlighting process executed in Step S112 (FIG. 4) of the image playback process described previously. During execution of this highlighting process, through the highlighting circuit 136 the image processing processor 130 first overlays the highlight image represented by the highlight information contained in the image file over the input image, and outputs the image (Step S300). That is, according to the present embodiment, if highlight information is recorded in an image file, a pre-specified portion on the image is shown in highlighted display, without the user having to perform any particular operation.

The image processing processor 130 then decides whether the Highlight button 124 of the control panel 120 has been pushed (Step S302). If the Highlight button 124 has been pushed, the image processing processor 130 decides whether a highlight image is currently being displayed (Step S304). If a highlight image is displayed, the image processing processor 130 deletes the highlight image through the highlighting circuit 136 (Step S306).

In Step S304, if the image processing processor 130 decides that no highlight image is currently being displayed, it redisplays the highlight image through the highlighting circuit 136 (Step S308). That is, according to the present embodiment, the system toggles between showing and hiding the highlight image each time that the Highlight button 124 is pushed.

In Step S302, if it is decided that the Highlight button has not been pushed, or after deletion (Step S306) or redisplay (Step S308) of the highlight image has taken place, the image processing processor 130 then decides whether there has been an operation using the Zoom button 126 or the Scroll button 127 (Step S310). If there has been an operation of Zoom button 126 or the Scroll button 127, a zooming/scrolling process is carried out by the zooming/scrolling circuit 138 (Step S312). This zooming/scrolling process is comparable to the zooming/scrolling process in the masking process described previously (see FIG. 6). In the absence of operation of the Zoom button 126 or the Scroll button 127, the image processing processor 130 skips Step S312.

Finally, the image processing processor 130 decides whether the Next Page button 122 has been pushed (Step S314). If the Next Page button 122 has not been pushed, the image processing processor 130 returns the process to Step S302. On the other hand, if the Next Page button 122 has been pushed, the highlighting process terminates. If this highlighting process is terminated, the image processing processor 130 returns the process to the image playback process illustrated in FIG. 4. Accordingly, the next image file is loaded by Step S100 of the image playback process.

According to the present embodiment described above, a placement location and a range for a mask image or a highlight image are established beforehand in each image file, thus eliminating the need to make these settings during the presentation. The presentation may proceed smoothly as a result. Further, according to the present embodiment, provided that mask information is recorded in the image file, the mask image is overlaid onto the input image automatically. Thus, situations in which a portion to be masked is displayed prior to the mask image do not arise. As a result, in a setting such as a classroom, it is possible to avoid premature display of the answer portion of an image representing an examination paper.

Additionally, in the present embodiment, because the mask information or highlight information is recorded in the EXIF information in the image file, it is possible to overlay mask images or highlight images without reducing the amount of image data per se. Thus, once a mask image or highlight image is deleted, the image that was concealed behind it may be readily redisplayed. Moreover, provided that mask information or highlight information is recorded in the EXIF information of the image file, there is no need to manage the mask information or highlight information separately from the image data, making handling of the data easier.

Further, according to the present embodiment, if the input image is digitally zoomed or scrolled, the mask image or highlight image is digitally zoomed or scrolled in the same manner as the input image. This avoids situations in which a masked portion is inadvertently exposed or a highlighted portion shifts out of position as a result of digital zooming or scrolling of the input image. From the preceding description it will be appreciated that convenience of the masking function and the highlighting function may be considerably improved according to the presentation device 100 of the present embodiment.

### C. Modifications

While the invention has been described herein in terms of a presently preferred embodiment, it is to be understood that there is no intention to limit the invention to the embodiment herein, and that various other features may be adopted within the spirit and scope of the invention. Possible modifications include the following for example.

### Modification 1:

In the embodiment described previously, if highlight information is recorded in the image file, a highlight image is overlaid on the input image automatically. However, as another exemplary arrangement, if highlight information is recorded in the image file, the input image is initially displayed with reduced tone, and the highlight image is not overlaid on the input image until the Highlight button is pressed. This makes it possible to bring up the highlighted display at user-selected timing.

### Modification 2:

In the embodiment described previously, the highlight image display is fixed at the coordinates specified by the highlight information. However, the highlight image may be designed to be moveable over the input image through an operation from the control panel 120. Likewise, mask images may be moveable as well.

### Modification 3:

In the embodiment described previously, only a single highlight image at a time is overlaid over an input image. However, an arrangement in which multiple highlight images are overlaid on the input image in a comparable manner to mask images is also acceptable. However, when overlaying multiple highlight images, if the highlighted area of a given highlight image should overlap the masking area of another highlight image, the transparence of the highlighted area is assigned precedence over the transparence of the masking area. This feature avoids situations in which the highlighted area of a given highlight image is covered by the masking area of another highlight image.

### Modification 4:

In the embodiment described previously, digital zooming or scrolling of a mask image or highlight image together with the input image takes place in response to a digital zooming or scrolling operation. As an additional feature, if the input image is rotated, the mask image or highlight image may be rotated as well, according to the angle of rotation.

### Modification 5:

In the embodiment described previously, deletion of mask images takes place according to the sequence (the rank) in which they were recorded in the mask information. However, as an alternative feature, deletion and redisplay of mask images may be carried out individually for each mask image. For example, according to this feature, with the control panel 120 or the remote control 190, the user moves the focus of a cursor sequentially among display locations for mask images (including both current display locations and locations for creating a display), while pushing the Mask button at each desired location to toggle between display and non-display of a mask image at that location. The convenience of the masking function may be further enhanced thereby.

### Modification 6:

A feature of the embodiment described previously is that when the Next Page button 122 is pushed, the next image file is loaded; as an additional feature, a Previous Page button may be provided, and when the Previous Page button is pushed, the previous image file is loaded.

### Modification 7:

In the embodiment described previously, overlay information (mask information and highlight information) is recorded in EXIF information in the image file. However, overlay information is not limited to being recorded in the EXIF information, and may be recorded in some other area in the image file. Also, overlay information may be recorded separately from the image file. For example, it may be recorded to the memory card 300 as overlay information data separate from the image file. It may also be recorded in memory in the presentation device 100. Where image files and overlay information are managed separately in this way, an association is created between the file name of an image file and the corresponding overlay information. Through this arrangement it is possible to appropriately acquire the overlay information associated with an acquired image file.

### Modification 8:

In the embodiment described previously, the images overlaid by mask images or highlight images are displayed on an external display device such as the liquid crystal display 200. However, images could also be output to a computer connected to the USB terminal 156.

### Modification 9:

In the embodiment described previously, mask images and highlight images are respectively displayed on different screens. However, by allowing a combination of mask information and highlight information to be recorded in the overlay information of an image file, where a combination of these is contained in an image file both mask images and highlight images may be displayed on the same screen. This feature makes it possible to carry out a more diversified presentation.

What is claimed is:

1. A presentation device comprising:
an image data acquisition portion that acquires image data which represents a first image;
an overlay information acquisition portion that acquires overlay information which has recorded therein in advance at least a placement location for a second image to be overlaid onto the first image for the purpose of masking or highlighted display of at least a portion of the first image;
an image processing portion that upon acquisition of overlay information associated with the acquired image data, overlays the second image on the first image represented by the acquired image data based on the acquired overlay information, and outputs the overlaid image; and
a control input receiving portion adapted to receive a control input to delete the second image;
wherein in the event that the control input is received by the control input receiving portion, the image processing portion outputs the first image after deleting the second image from the overlaid image.

2. The presentation device according to claim 1, wherein
if two or more placement locations of the second image are recorded in the acquired overlay information, the image processing portion overlays the second image on the respective locations; and
the image processing portion deletes the second images according to a prescribed sequence, each time that the control input is received by the control input receiving portion.

3. The presentation device according to claim 2, wherein
the overlay information contains sequence information relating to a sequence for carrying out the deletion; and
the image processing portion carries out deletion of the second images according to the sequence information.

4. The presentation device according to claim 2, wherein
if the control input is received by the control input receiving portion subsequent to deletion of all of the second images, the image processing portion again overlays all of the second images on the first image.

5. The presentation device according to claim 1, wherein
the overlay information records class information representing classes of the second image; and
the image processing portion overlays a second image having a format in accordance with the class information.

6. The presentation device according to claim 1, wherein
the overlay information is recorded in the image file that contains the image data.

7. The presentation device according to claim 1 further comprising:
an overlay information storage portion that stores the overlay information in a form associated with the image data;
wherein the overlay information acquisition portion acquires the overlay information from the overlay information storage portion.

8. The presentation device according to claim 1, wherein
the control input receiving portion is additionally adapted to receive a command to zoom or scroll the first image; and
the image processing portion zooms or scrolls the first image by a magnification factor or by a distance in accordance with the zoom or scroll command, and likewise zooms or scrolls the second image by the magnification factor or by the distance.
